(19) United States
(12) Patent Application Publication
(10) Pub. No.: US 2013/0107168 A1
(43) Pub. Date: May 2, 2013

(54) BACKLIGHT MODULE AND LIQUID CRYSTAL DISPLAY

(71) Applicants: Guofu Tang, Shenzhen (CN); Gang Yu, Shenzhen (CN)

(72) Inventors: Guofu Tang, Shenzhen (CN); Gang Yu, Shenzhen (CN)

(73) Assignee: SHENZHEN CHINA STAR OPTOELECTRONICS TECHNOLOGY CO., LTD., Shenzhen (CN)

(21) Appl. No.: 13/375,420

(22) PCT Filed: Nov. 9, 2011
(86) PCT No.: PCT/CN2011/081978

§ 371 Date: Nov. 30, 2011

(30) Foreign Application Priority Data
Nov. 1, 2011 (CN) 201110339975.3

(51) Int. Cl. G02F 1/13357; F21V 7/04

(52) U.S. Cl. 349/62; 362/606

(57) ABSTRACT

A backlight module is provided, including a light guide plate, a back plate, a plastic frame, an optical film and a light source. The plastic frame forms a receiving cavity and an accommodation cavity. The light guide plate is mounted in the receiving cavity and located above the back plate. The optical film is mounted in the accommodation cavity and placed on a light exit surface of the light guide plate. The receiving cavity at least includes a vertical end surface and an inclined sidewall. The accommodation cavity at least includes a horizontal support surface and a shading surface. The backlight module and the liquid crystal display of the present invention employ the receiving cavity located above the light guide plate to fix the optical film thereby efficiently shortening the shading surface.

### BACKGROUND OF THE INVENTION

1. Field of the Invention

The present invention relates to a technology field of liquid crystal display field, and more particularly to a backlight module and a liquid crystal display for fixing an optical film by a receiving cavity formed above a light guide plate and efficiently shortening a shading surface.

2. Description of the Prior Art

At present, a light guide plate of a liquid crystal display has many light incidence modes and generally adopts a light incidence mode of a reflection type to get a best result. FIG. 1 shows a structure of a backlight module 100 of a prior liquid crystal display. The backlight module 100 comprises a light guide plate 110, a back plate 120, a plastic frame 130, an optical film 140 and a light source 150. In the structure of this backlight module 100, though the optical film 140 may be better supported, a shading portion located on the plastic frame 130 and used to shade a peripheral edge of the optical film 140 cannot be efficiently shortened and will lower the light output efficiency.

FIG. 2 shows a structure of a backlight module 200 of another prior liquid crystal display. The backlight module 200 comprises a guide light plate 210, a back plate 220, a plastic frame 230, an optical film 240 and a light source 250. In the structure of this backlight module 200, though a shading portion of the plastic frame 230 may be efficiently shorten, the light guide plate 210 cannot better support the optical film 240 because a vertical distance exists between the optical film 240 and the light guide plate 210. Therefore, this structure cannot assure the planeness of the optical film 240 and it will result in the uneven brightness of a display panel (not shown in drawings).

Hence, it is necessary to provide a backlight module and a liquid crystal display for solving the problem existing in the prior art.

### BRIEF SUMMARY OF THE INVENTION

One object of the present invention is to provide a backlight module and a liquid crystal display to solve the technical problems that a shading portion of a plastic frame cannot be efficiently shortened and the brightness of a display panel is uneven in the prior art.

Another object of the present invention is to provide a backlight module and a liquid crystal display, being capable of efficiently shortening a shading portion of a plastic frame and assuring the even brightness of a display panel.

Other objects and advantages of the present invention may be further understood from the technical features disclosed by the present invention.

To achieve the aforementioned objects or other objects of the present invention, the present invention adopts the following technical solution.

A backlight module comprises a light guide plate, a back plate, a plastic frame, an optical film and a light source. Wherein the plastic frame forms a receiving cavity and an accommodation cavity located above the receiving cavity and communicating with the receiving cavity. The light guide plate is mounted in the receiving cavity and located above the back plate. The optical film is mounted in the accommodation cavity and placed on a light exit surface of the light guide plate. Wherein, the receiving cavity at least includes a vertical end surface and an inclined sidewall connected to the vertical end surface. The vertical end surface is used to fix the guide light plate. There forms a space under the inclined sidewall to receive the light source. The accommodation cavity at least includes a horizontal support surface and a shading surface facing the horizontal support surface. The horizontal support surface is perpendicularly connected to the vertical end surface. The horizontal support surface is used to load a peripheral edge of the optical film. The shading surface is located above the peripheral edge of the optical film. An end portion of the shading surface exceeds the vertical end surface. The inclined sidewall is a reflective inclined surface, and a reflective layer adheres to or is plated on it. The horizontal support surface is lower than the light exit surface of the light guide plate. The light source is disposed under the reflective inclined surface. The vertical end surface is closer than any side surface of the light source to a light incidence surface of the light guide plate. The backlight module further comprises a heat-dispersing board. The light guide plate is fixed on the back plate by the heat-dispersing board. A driver board of the light source is connected to the back plate by the heat-dispersing board or is directly connected to the back plate. The plastic frame is a white or black plastic frame.

A backlight module comprises a light guide plate, a back plate, a plastic frame, an optical film and a light source. Wherein the plastic frame forms a receiving cavity and an accommodation cavity located above the receiving cavity and communicating with the receiving cavity. The light guide plate is mounted in the receiving cavity and located above the back plate. The optical film is mounted in the accommodation cavity and placed on a light exit surface of the light guide plate. Wherein, the receiving cavity at least includes a vertical end surface and an inclined sidewall connected to the vertical end surface. The vertical end surface is used to fix the guide light plate. There forms a space under the inclined sidewall to receive the light source. The accommodation cavity at least includes a horizontal support surface and a shading surface facing the horizontal support surface. The horizontal support surface is perpendicularly connected to the vertical end surface. The horizontal support surface is used to load a peripheral edge of the optical film. The shading surface is located above the peripheral edge of the optical film.

In the backlight module of the present invention, an end portion of the shading surface exceeds the vertical end surface.

In the backlight module of the present invention, the inclined sidewall is a reflective inclined surface, which forms a reflective layer adhering thereto or being plated thereon; and the horizontal support surface is lower than the light exit surface of the light guide plate.

In the backlight module of the present invention, the light source is disposed under the reflective inclined surface, and the vertical end surface is closer than any side surface of the light source to a light incidence surface of the light guide plate.

In the backlight module of the present invention, the backlight module further comprises a heat-dispersing board, and the light guide plate is fixed on the back plate by the heat-dispersing board.

In the backlight module of the present invention, a driver board of the light source is connected to the back plate by the heat-dispersing board or is directly connected to the back plate.

In the backlight module of the present invention, the plastic frame is a white or black plastic frame.

To achieve the aforementioned objects or other objects of the present invention, the present invention also adopts the following technical solution. A liquid crystal display comprises a backlight module and a display panel. The backlight module comprises a light guide plate, a back plate, a plastic frame, an optical film and a light source. Wherein the plastic frame forms a receiving cavity and an accommodation cavity located above the receiving cavity and communicating with the receiving cavity. The light guide plate is mounted in the receiving cavity and located above the back plate. The optical film is mounted in the accommodation cavity and placed on a light exit surface of the light guide plate. Wherein, the receiving cavity at least includes a vertical end surface and an inclined sidewall connected to the vertical end surface. The vertical end surface is used to fix the guide light plate. There forms a space under the inclined sidewall to receive the light source. The accommodation cavity at least includes a horizontal support surface and a shading surface facing the horizontal support surface. The horizontal support surface is perpendicularly connected to the vertical end surface. The horizontal support surface is used to load a peripheral edge of the optical film. The shading surface is located above the peripheral edge of the optical film.

In the liquid crystal display of the present invention, an end portion of the shading surface exceeds the vertical end surface.

In the liquid crystal display of the present invention, the inclined sidewall is a reflective inclined surface, which forms a reflective layer adhering thereto or being plated thereon; and the horizontal support surface is lower than the light exit surface of the light guide plate.

In the liquid crystal display of the present invention, the light source is disposed under the reflective inclined surface, and the vertical end surface is closer than any side surface of the light source to a light incidence surface of the light guide plate.

In the liquid crystal display of the present invention, the backlight module further comprises a heat-dispersing board, and the light guide plate is fixed on the back plate by the heat-dispersing board.

In the liquid crystal display of the present invention, a driver board of the light source is connected to the back plate by the heat-dispersing board or is directly connected to the back plate.

In the liquid crystal display of the present invention, the plastic frame is a white or black plastic frame.

Comparing with the prior art, the backlight module and the liquid crystal display of the present invention form the receiving cavity above the light guide plate to efficiently shorten the shading surface of the plastic frame and assure the even brightness of the display panel. The backlight module and the liquid crystal display of the present invention can solve the technical problems that a shading portion of a plastic frame of the prior backlight module and the prior liquid crystal display cannot be efficiently shortened and the brightness of a display panel is uneven.

For more clearly and easily understanding above content of the present invention, the following text will take a preferred embodiment of the present invention with reference to the accompanying drawings for detail description as follows.

### BRIEF DESCRIPTION OF THE DRAWINGS

FIG. 1 is a structural schematic view of a backlight module of one liquid crystal display of the prior art;

FIG. 2 is a structural schematic view of a backlight module of another liquid crystal display of the prior art; and

FIG. 3 is a structural schematic view of a preferred embodiment of a backlight module of a liquid crystal display of the present invention.

### DETAILED DESCRIPTION OF THE PREFERRED EMBODIMENTS

The following description of every embodiment with reference to the accompanying drawings is used to exemplify a specific embodiment, which may be carried out in the present invention. Directional terms mentioned in the present invention, such as “top”, “bottom”, “front”, “back”, “left”, “right”, “inside”, “outside”, “side” etc., are only used with reference to the orientation of the accompanying drawings. Therefore, the used directional terms are intended to illustrate, but not to limit, the present invention.

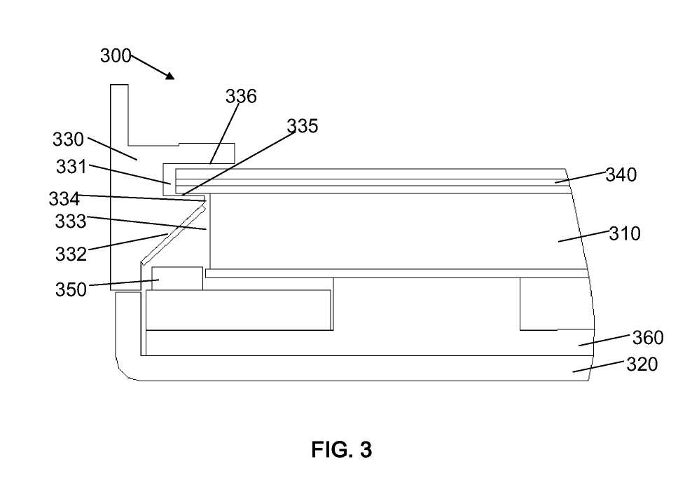

Please refer to FIG. 3, which shows a structural schematic view of a preferred embodiment of a backlight module of a liquid crystal display of the present invention, the backlight module 300 comprises a light guide plate 310, a back plate 320, a plastic frame 330, an optical film 340 and a light source 350. The plastic frame 330 is a frame structure, which has four similar frame walls. FIG. 3 only shows one of the frame walls. In this embodiment, it will take one of the frame walls as an example to describe the specific structure of the plastic frame 330.

As shown in FIG. 3, in the plastic frame 330, the four frame walls together define a receiving cavity 333 and an accommodation cavity 331 located above the receiving cavity 333 and communicating with the receiving cavity 333. The light guide plate 310 is mounted in the receiving cavity 333 of the plastic frame 330 and located above the back plate 320. The optical film 340 is mounted in the accommodation cavity 331 of the plastic frame 330, and is directly placed on an upper surface (namely a light exit surface) of the light guide plate 310. Therefore, the optical film 340 can be supported by the light guide plate 310 thereby ensuring that the backlight module 300 can provide an even brightness for a display panel (not shown in drawings).

As shown in FIG. 3, the receiving cavity 333 of the plastic frame 330 at least includes a vertical end surface 334 and an inclined sidewall 332 connected to the vertical end surface 334. The vertical end surface 334 is used to fix the guide light plate 310 located in the receiving cavity 333, and the structure and function thereof is to be further described in the following text. There forms a space under the inclined sidewall 332 to receive the light source 150. Accordingly, in this embodiment, the inclined sidewall 332 is used as a light-reflecting inclined surface to reflect the light coming from the light source 150 unto a light incidence surface of the light guide plate 310.

As shown in FIG. 3, the accommodation cavity 331 of the plastic frame 330 at least includes a horizontal support surface 335 and a shading surface 336. The horizontal support surface 335 is perpendicularly connected to the vertical end surface 334. The horizontal support surface 335 is used to support a peripheral edge of the optical film 340 located in the accommodation cavity 331. The shading surface 336 is parallel to the horizontal support surface 335 and is located above the peripheral edge of the optical film 340 for preventing the light leakage.

As shown in FIG. 3, an end portion of the shading surface 336 of the accommodation cavity 331 exceeds the horizontal support surface 335 in the horizontal direction. Namely, the end portion of the shading surface 336 of the accommodation cavity 331 exceeds the vertical end surface 334 of the receiving cavity 333 in the horizontal direction. By this arrangement, the optical film 340 may be held in the receiving cavity 333, be directly supported by the light guide plate 310 and prevent the light leakage by the shading surface 336.

The following text will further describe the detail structure of the backlight module 300 of the present invention and the function thereof.

According to the design of the accommodation cavity 331 of the backlight module 300 of the present invention, the peripheral edge of the optical film 340 extends over the peripheral edge of the backlight module 310. Therefore, the accommodation cavity 331 may better fix the optical film 340 therein, the contact portion (namely the shading surface 336) of the accommodating cavity 331 contacting with the optical film 340 may be efficiently shortened, and the light exit effect of the shading surface 336 impacting on the light exit surface of the light guide plate 310 is reduced as much as possible, so that the backlight module 300 realizes the design of an ultra-narrow frame. Moreover, the optical film 340 is directly disposed on the surface of the light guide plate 310 so that being capable of being efficiently supported by the light guide plate 310, and the phenomenon of uneven brightness does not appear on the display panel (not shown in drawings).

In the structural schematic view of the preferred embodiment of the backlight module of the liquid crystal display of the present invention shown by FIG. 3, the inclined sidewall 332 of the plastic frame 330 is used as the light-reflecting inclined surface. For example, it may form a reflective layer in the inclined sidewall 332. The backlight module 310 of the present invention adopts a light incidence mode of a reflection type. The light emitted by the light source 350 is reflected by the reflective layer on the inclined sidewall 332 and then is incident upon the light incidence surface of the light guide plate 310, thereby being convenient for designing the position of the light source 350 and making the light incidence effect of the light guide plate 3323 be better. The reflective layer also may be formed by other modes, such as adhesive deposition, vapor deposition and so on according to the demands of the user.

In the structural schematic view of the preferred embodiment of the backlight module of the liquid crystal display of the present invention shown by FIG. 3, the vertical end surface 334 of the plastic frame 330 is vertically connected to the reflective surface (the inclined sidewall 332), and a top portion of the vertical end surface 334 is lower than the light exit surface of the light guide plate 310 (namely the horizontal support surface 335 is lower than the light exit surface of the light guide plate 310). Moreover, the light source 350 is disposed under the light-reflecting inclined surface (the inclined sidewall 332), and the vertical end surface 334 is slightly closer than any side surface of the light source 350 to the light incidence surface of the light guide plate 310 for protecting the light source 350.

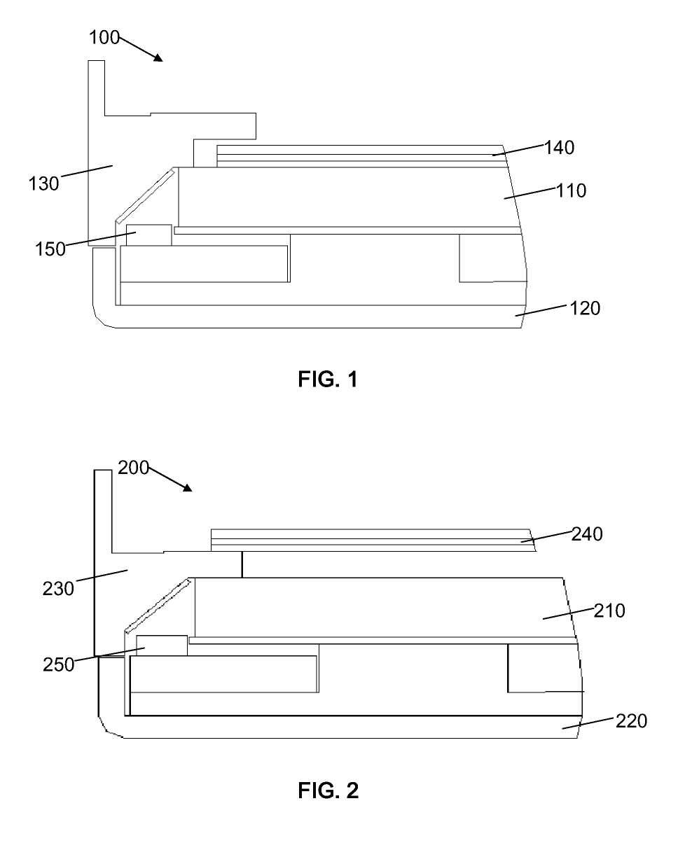

The prior backlight module is as shown by FIGS. 1 and 2, the reflective inclined surface is very easy to be impacted by the light guide plate. According to the force resolution of the mechanical principles, the plastic frame will deform upward, and that may be result in the display panel (not shown in drawings) above the plastic frame being broken. But because the backlight module 300 of the present invention disposes the protruding vertical end surface 334, the light guide plate 310 cannot directly impact unto the reflective inclined surface (the inclined sidewall 332), but impact unto the protruding vertical end surface 334, thereby avoiding the upward deformation of the plastic frame 330. Moreover, because the vertical end surface 334 is closer than any side surface of the light source 350 to the light incidence surface of the light guide plate 310, the vertical end surface 334 can prevent the light source 350 from being impacted by the light guide plate 310, thereby making the backlight module 300 of the present invention be more stable. Furthermore, the top end of the vertical end surface 334 (namely the horizontal support surface 335) is lower than the light exit surface of the light guide plate 310 for being convenient to mount the optical film 340. For example, when the optical film 340 is mounted into the accommodation cavity 331, the horizontal support surface 335 cannot prevent the optical film 340 from entering into the receiving cavity 331.

In the structural schematic view of the preferred embodiment of the backlight module of the liquid crystal display of the present invention shown by FIG. 3, the backlight module 300 also comprises a heat-dispersing board 360. The light guide plate 310 is fixed on the back plate 320 by the heat-dispersing board 360. A driver board of the light source 350 is connected to the back plate 320 by the heat-dispersing board 360 or is directly connected to the back plate 320. If the light source 350 adopts a high-power LED, the heat-dispersing problem of the light source 350 will largely affect the useful life and the stability of the backlight module 300. The backlight module 300 of the present invention also comprises a heat-dispersing board 360. The light guide plate 310 is fixed on the back plate 320 by the heat-dispersing board 360 to assure the good heat dissipation characteristic of the light guide plate 310. And the user according to the heating circumstance of the used light source 350 may determine whether the driver board of the light source 350 is disposed on the back plate 320 by the heat-dispersing board 360 (when the generated heat is larger) or directly disposed on the back plate 320 (when the generated heat is littler).

To be the preferred embodiment of the backlight module of the liquid crystal of the present invention, the plastic frame 330 of the backlight module 300 of the present invention may be a white or black plastic frame. The plastic frame makes the backlight module 300 bear some inner or outer impact for assuring the stability of the backlight module 300 during using. Additionally, the white or black plastic frame does not greatly affect the color of the emitted light of the light guide plate 310.

The present invention also relates to a liquid crystal display, comprising a backlight module and a display panel. The backlight module comprises a light guide plate, a back plate, a plastic frame, an optical film and a light source. Wherein the plastic frame forms a receiving cavity and an accommodation cavity located above the receiving cavity and communicating with the receiving cavity. The light guide plate is mounted in the receiving cavity and located above the back plate. The optical film is mounted in the accommodation cavity and placed on a light exit surface of the light guide plate. Wherein, the receiving cavity at least includes a vertical end surface and an inclined sidewall connected to the vertical end surface. The vertical end surface is used to fix the guide light plate. There forms a space under the inclined sidewall to receive the light source. The accommodation cavity at least includes a horizontal support surface and a shading surface facing the horizontal support surface. The horizontal support surface is perpendicularly connected to the vertical end surface. The horizontal support surface is used to load a peripheral edge of the optical film. The shading surface is located above the peripheral edge of the optical film. An end portion of the shading surface exceeds the vertical end surface. The inclined sidewall is a reflective inclined surface, and a reflective layer adheres to or is plated on it. The horizontal support surface is lower than the light exit surface of the light guide plate. The light source is disposed under the reflective inclined surface. The vertical end surface is closer than any side surface of the light source to a light incidence surface of the light guide plate. The embodiment and the beneficial effect of the liquid crystal display of the present invention are same or similar to those of above backlight module. Please refer to the embodiment of the abovementioned backlight module.

In conclusion, although the present invention has been disclosed by above preferred embodiments, above preferred embodiments are not used to limit the present invention. One of ordinary skills in the art also can make all sorts of improvements and amendments within the principles of the present invention. Therefore, the protection scope of the present invention should be based on the scope defined by the appended claims.

What is claimed is:

1. A backlight module, comprising a light guide plate, a back plate, a plastic frame, an optical film and a light source, characterized in that: the plastic frame forming a receiving cavity and an accommodation cavity located above the receiving cavity and communicating with the receiving cavity, the light guide plate being mounted in the receiving cavity and located above the back plate; the optical film being mounted in the accommodation cavity and placed on a light exit surface of the light guide plate; wherein
the receiving cavity at least including a vertical end surface and an inclined sidewall connected to the vertical end surface, the vertical end surface being used to fix the guide light plate; there forming a space under the inclined sidewall to receive the light source;
the accommodation cavity at least including a horizontal support surface and a shading surface facing the horizontal support surface, the horizontal support surface being perpendicularly connected to the vertical end surface, the horizontal support surface being used to load a peripheral edge of the optical film; the shading surface being located above the peripheral edge of the optical film;
an end portion of the shading surface exceeding the vertical end surface;
the inclined sidewall being a reflective inclined surface, which forms a reflective layer adhering thereto or being plated thereon; the horizontal support surface being lower than the light exit surface of the light guide plate;
the light source being disposed under the reflective inclined surface, the vertical end surface being closer than any side surface of the light source to a light incidence surface of the light guide plate;
the backlight module further comprising a heat-dispersing board, the light guide plate being fixed on the back plate by the heat-dispersing board;
a driver board of the light source being connected to the back plate by the heat-dispersing board or being directly connected to the back plate; and
the plastic frame being a white or black plastic frame.

2. A backlight module, comprising a light guide plate, a back plate, a plastic frame, an optical film and a light source, characterized in that: the plastic frame forming a receiving cavity and an accommodation cavity located above the receiving cavity and communicating with the receiving cavity, the light guide plate being mounted in the receiving cavity and located above the back plate; the optical film being mounted in the accommodation cavity and placed on a light exit surface of the light guide plate; wherein
the receiving cavity at least including a vertical end surface and an inclined sidewall connected to the vertical end surface, the vertical end surface being used to fix the guide light plate; there forming a space under the inclined sidewall to receive the light source; and
the accommodation cavity at least including a horizontal support surface and a shading surface facing the horizontal support surface, the horizontal support surface being perpendicularly connected to the vertical end surface, the horizontal support surface being used to load a peripheral edge of the optical film; the shading surface being located above the peripheral edge of the optical film.

3. The backlight module as claimed in claim 2, characterized in that: an end portion of the shading surface exceeds the vertical end surface.

4. The backlight module as claimed in claim 3, characterized in that: the inclined sidewall is a reflective inclined surface, which forms a reflective layer adhering thereto or being plated thereon; and the horizontal support surface is lower than the light exit surface of the light guide plate.

5. The backlight module as claimed in claim 4, characterized in that: the light source is disposed under the reflective inclined surface, and the vertical end surface is closer than any side surface of the light source to a light incidence surface of the light guide plate.

6. The backlight module as claimed in claim 2, characterized in that: the backlight module further comprises a heat-dispersing board, and the light guide plate is fixed on the back plate by the heat-dispersing board.

7. The backlight module as claimed in claim 6, characterized in that: a driver board of the light source is connected to the back plate by the heat-dispersing board or is directly connected to the back plate.

8. The backlight module as claimed in claim 2, characterized in that: the plastic frame is a white or black plastic frame.

9. A liquid crystal display, comprising a backlight module and a display panel, the backlight module comprising a light guide plate, a back plate, a plastic frame, an optical film and a light source, characterized in that: the plastic frame forming a receiving cavity and an accommodation cavity located above the receiving cavity and communicating with the receiving cavity, the light guide plate being mounted in the receiving cavity and located above the back plate; the optical film being mounted in the accommodation cavity and placed on a light exit surface of the light guide plate; wherein
the receiving cavity at least including a vertical end surface and an inclined sidewall connected to the vertical end surface, the vertical end surface being used to fix the guide light plate; there forming a space under the inclined sidewall to receive the light source; and
the accommodation cavity at least including a horizontal support surface and a shading surface facing the horizontal support surface, the horizontal support surface being perpendicularly connected to the vertical end surface, the horizontal support surface being used to load a peripheral edge of the optical film; the shading surface being located above the peripheral edge of the optical film.

10. The liquid crystal display as claimed in claim 9, characterized in that: an end portion of the shading surface exceeds the vertical end surface.

11. The liquid crystal display as claimed in claim 10, characterized in that: the inclined sidewall is a reflective inclined surface, which forms a reflective layer adhering thereto or being plated thereon; and the horizontal support surface is lower than the light exit surface of the light guide plate.

12. The liquid crystal display as claimed in claim 11, characterized in that: the light source is disposed under the reflective inclined surface, and the vertical end surface is closer than any side surface of the light source to a light incidence surface of the light guide plate.

13. The liquid crystal display as claimed in claim 9, characterized in that: the backlight module further comprises a heat-dispersing board, and the light guide plate is fixed on the back plate by the heat-dispersing board.

14. The liquid crystal display as claimed in claim 13, characterized in that: a driver board of the light source is connected to the back plate by the heat-dispersing board or is directly connected to the back plate.

15. The liquid crystal display as claimed in claim 9, characterized in that: the plastic frame is a white or black plastic frame.
